(19) United States
(12) Patent Application Publication
(10) Pub. No.: US 2009/0174504 A1
(43) Pub. Date: Jul. 9, 2009

(54) ULTRA WIDEBAND FILTER

(75) Inventor: CHIA-HAO MEI, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/133,383

(22) Filed: Jun. 5, 2008

(30) Foreign Application Priority Data
Jan. 4, 2008 (TW) 97100330

(51) Int. Cl. H01P 1/203

(52) U.S. Cl. 333/204

(57) ABSTRACT

An ultra wideband (UWB) filter (20) disposed on a substrate (10). The UWB filter includes a first transmission portion (22), a second transmission portion (24), a connection portion (26), and a grounded portion (28). The first transmission portion is used for transmitting electromagnetic signals. The second transmission portion is used for transmitting the electromagnetic signals. The connection portion directly and electronically connects the first transmission portion to the second transmission portion. The grounded portion is electronically connected to the first transmission portion.

### BACKGROUND OF THE INVENTION

1. Field of the Invention

The present invention relates to filters, and particularly to an ultra wideband filter.

2. Description of Related Art

In recent years, ultra wideband (UWB) communication technology, a communication technology that uses an extremely wide frequency band and allows high-speed broadband wireless communication, has become more and more popular. The UWB communication technology uses a frequency band of 3.1 GHz-10.6 GHz, which enables high-speed communication by exclusively using an extremely wide frequency band of several GHz width. A filter is an important element for a UWB communication product.

It is well-known that a filter is able to eliminate interference signals for a communication product. Features of an ideal filter are that signal attenuation is zero within a pass band and becomes infinite within a cut-off band, and a transition from the pass band to the cut-off band should be as sharp as possible.

Typically, people improve an efficiency of a filter by adding resonators thereto. However, addition of resonators will increase an area of the filter, thereby increasing the size of the electronic product utilizing the filter.

Therefore, a heretofore unaddressed need exists in the industry to overcome the aforementioned deficiencies and inadequacies.

### SUMMARY OF THE INVENTION

An exemplary embodiment of the present invention provides an ultra wideband (UWB) filter disposed on a substrate. The UWB filter includes a first transmission portion, a second transmission portion, a connection portion, and a grounded portion. The first transmission portion is used for transmitting electromagnetic signals. The second transmission portion is used for transmitting the electromagnetic signals. The connection portion directly and electronically connects the first transmission portion to the second transmission portion. The grounded portion is electronically connected to the first transmission portion.

Other advantages and novel features will become more apparent from the following detailed description when taken in conjunction with the accompanying drawings, in which:

### BRIEF DESCRIPTION OF THE DRAWINGS

FIG. 1 is a schematic plan view of an ultra wideband (UWB) filter of an exemplary embodiment of the present invention;

FIG. 2 is a schematic diagram illustrating dimensions of the UWB filter of FIG. 1;

FIG. 3 is a graph of test results showing a return loss of the UWB filter of FIG. 1;

FIG. 4 is another graph of test results showing a return loss of the UWB filter of FIG. 1;

FIG. 5 is a graph showing group delay of electromagnetic signals traveling through the UWB filter of FIG. 1; and

FIG. 6 is a schematic plan view of a UWB filter of another exemplary embodiment of the present invention.

### DETAILED DESCRIPTION OF THE INVENTION

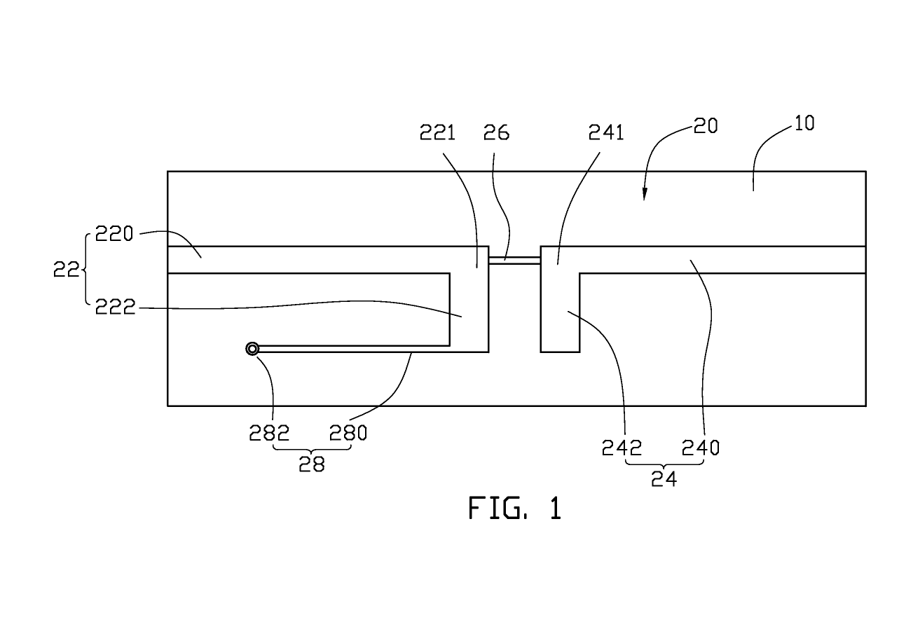

FIG. 1 is a schematic plan view of an ultra wideband (UWB) filter 20 according to an exemplary embodiment of the present invention. The UWB filter 20 is disposed on a substrate 10 and includes a first transmission portion 22, a second transmission portion 24, a connection portion 26, and a grounded portion 28.

In this embodiment, the first transmission portion 22 includes a first first-conductive section 220 and a first second-conductive 222 vertically and electronically connected to the first first-conductive section 220 at a first joint 221. In other words, the first transmission portion 22 is L-shaped. In particular, the length of the first first-conductive section 220 is greater than that of first second-conductive section 222.

The second transmission portion 24 comprises a second first-conductive section 240 and a second second-conductive section 242 vertically and electronically connected to the second first-conductive section 240 at a second joint 241. In other words, the second transmission portion 24 is L-shaped. In particular, the length of the second first-conductive section 240 is greater than that of the second second-conductive section 242. In this embodiment, the second transmission portion 24 is set as mirror image to the first transmission portion 22.

The connection portion 26 electronically connects the first transmission portion 22 to the second transmission portion 24. In this embodiment, the connection portion 26 directly and electronically connects the first joint 221 to the second joint 241. The connection portion 26 can cause coupling effect between the first transmission portion 22 and the second transmission portion 24.

The first first-conductive section 220 is aligned with the second first-conductive section 240. The first second-conductive section 222 is parallel to the second second-conductive section 242. The grounded portion 28 includes a connection end 280 electronically connected to the first transmission portion 22, and a grounded end 282. In this embodiment, the length of the grounded portion 28 is equal to a quarter wavelength of the working frequency of the UWB filter 20 to achieve a resonant function. The grounded end 282 is a via in the substrate 10.

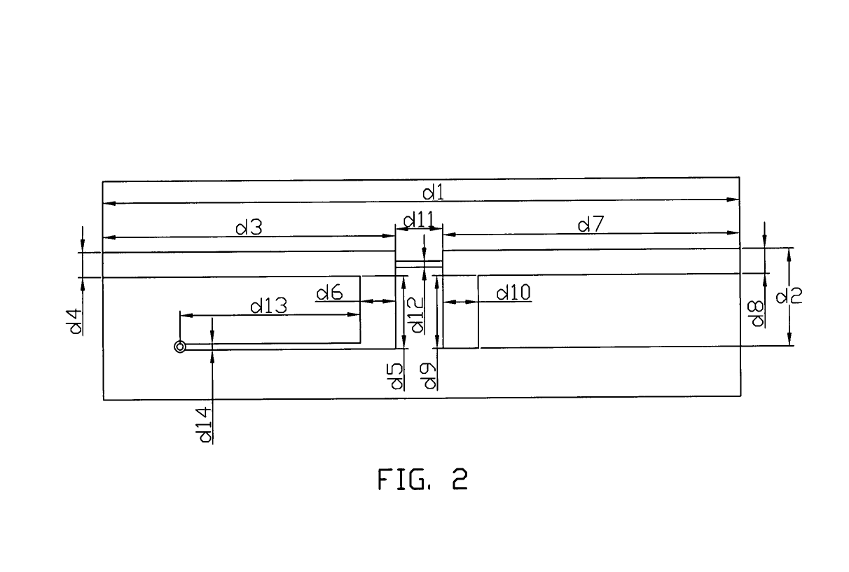

FIG. 2 is a schematic diagram illustrating dimensions of the UWB filter 20 of FIG. 1. In this embodiment, a total length d1 of the UWB filter 20 is about 13 millimeters (mm), and a total width d2 thereof is about 2 mm. A length d3 of the first first-conductive section 220 is about 6 mm, and a width d4 thereof is about 0.5 mm. A length d5 of first second-conductive section 222 is about 1.5 mm, and a width d6 thereof is about 0.75 mm. A length d7 of the second first-conductive section 240 is about 6 mm, and a width d8 thereof is about 0.5 mm. A length d9 of the second second-conductive section 242 is about 1.5 mm, and a width d10 thereof is about 0.75 mm. A length d11 of the connection portion 26 is about 1 mm, and a width d12 thereof is about 0.125 mm. A length d13 of the grounded portion 28 is about 3.8 mm, and a width d14 thereof is about 0.125 mm.

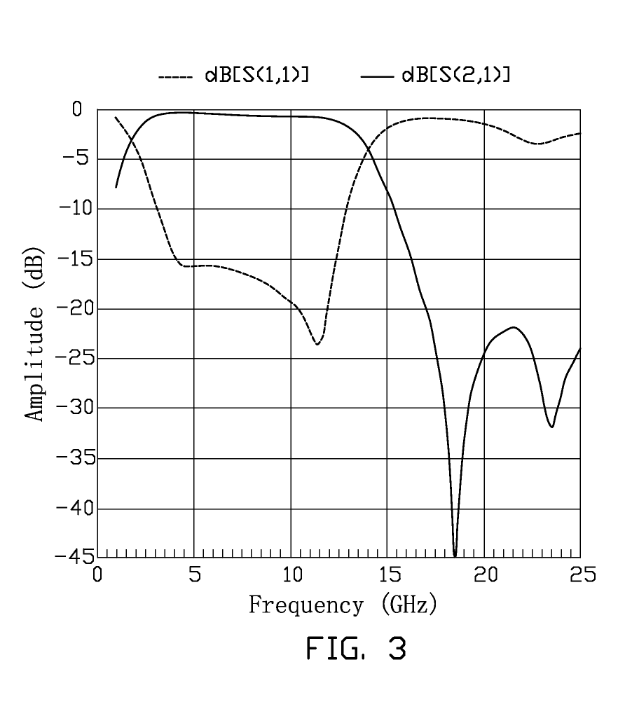

FIG. 3 is a graph of test results showing a return loss of the UWB filter 20 of FIG. 1 when the electromagnetic signals travel from the first transmission portion 22 to the second transmission portion 24. As shown in FIG. 3, a horizontal axis represents the frequency (in GHz) of the electromagnetic signals traveling through the UWB filter 20, and a vertical axis represents the amplitude of insertion/return loss (in dB) of the UWB filter 20. The insertion loss of the electromagnetic signals traveling through the UWB filter 20 is indicated by a curve labeled dB[S(2,1)] representing a relationship between an input power and an output power of the electromagnetic signals traveling through the UWB filter 20, and the insertion loss is represented by the following equation:

Insertion Loss=10*Log [(Output Power)/(Input Power)]

When the electromagnetic signals travel through the UWB filter 20, a part of the input power is returned to a source of the electromagnetic signals. The part of the input power returned to the source of the electromagnetic signals is called a return power. The return loss of the electromagnetic signals traveling through the UWB filter 20 is indicated by the dashed curve labeled dB[S(1,1)], representing a relationship between input power and return power of the electromagnetic signals traveling through the UWB filter 20, and the return loss is represented by the following equation:

Return Loss=10*Log [(Return Power)/(Input Power)]

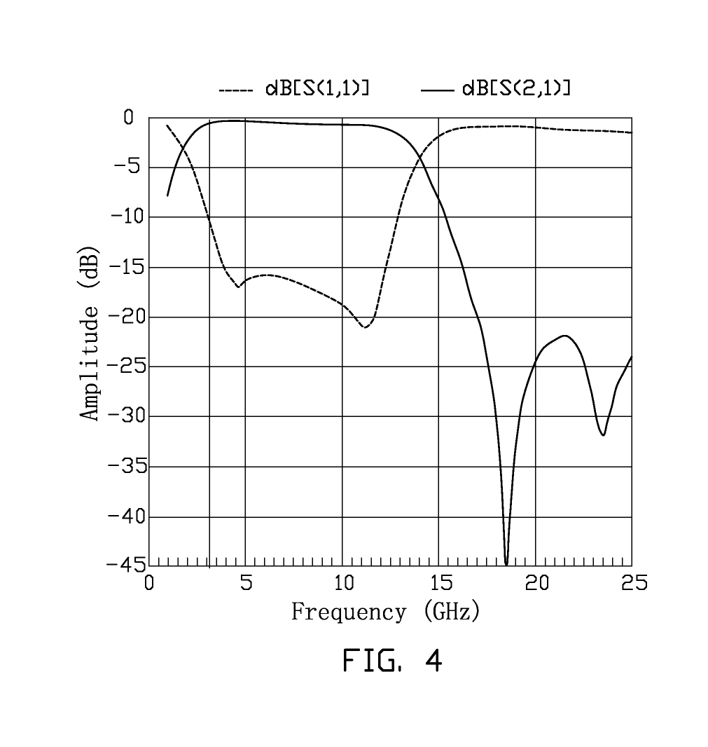

FIG. 4 is another graph of test results showing a return loss of the UWB filter 20 of FIG. 1 when the electromagnetic signals travel from the second transmission portion 24 to the first transmission portion 22.

For the UWB filter 20, when an output power of electromagnetic signals in a band pass frequency range is almost equal to an input power thereof, and a return power of the electromagnetic signals is small, it means that a distortion of the electromagnetic signals is small and a performance of the UWB filter 20 is good. As shown in FIG. 3 and FIG. 4, the UWB filter 20 has a good performance as a UWB filter. The absolute amplitude of the return loss in the band pass frequency range is greater than 10. The absolute amplitude of the insertion loss in the band pass frequency range is about 0.

Referring to the FIG. 3 and FIG. 4, the UWB filter 20 has a bi-directional work function.

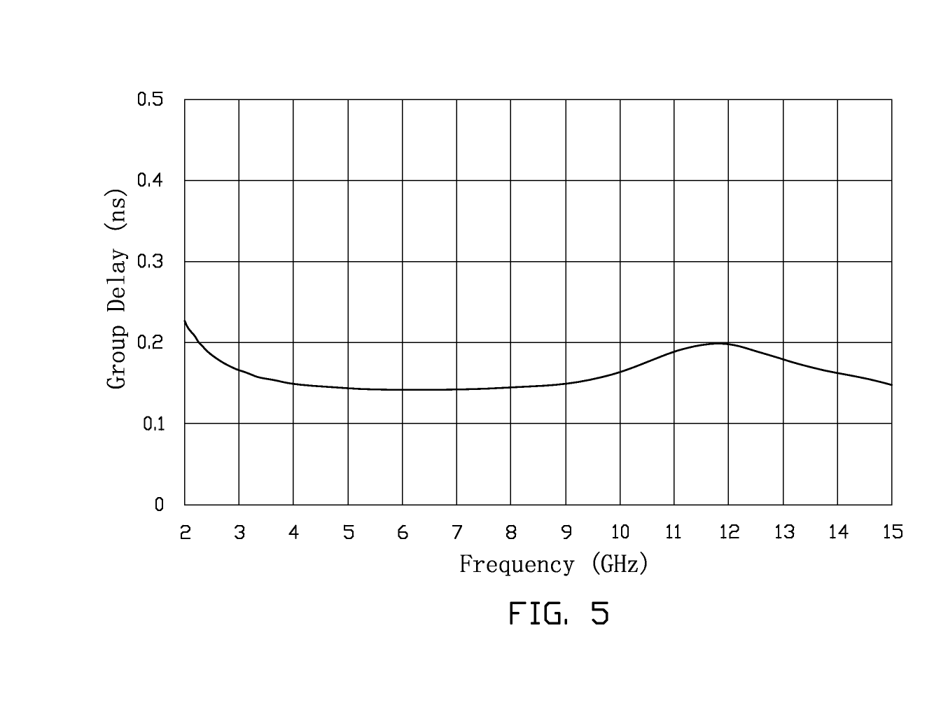

FIG. 5 is a graph showing a group delay of electromagnetic signals traveling through the UWB filter 20 of FIG. 1. The horizontal axis represents the frequency (in GHz) of the electromagnetic signals traveling through the UWB filter 20, and the vertical axis represents a group delay of the electromagnetic signals. The group delay of the UWB filter 20 over the range of frequencies is indicated by a curve. As shown in FIG. 5, the amplitudes of the group delay in the band pass frequency range are less than 0.18 nanoseconds, indicating the UWB filter 20 qualifies for application of a UWB filter.

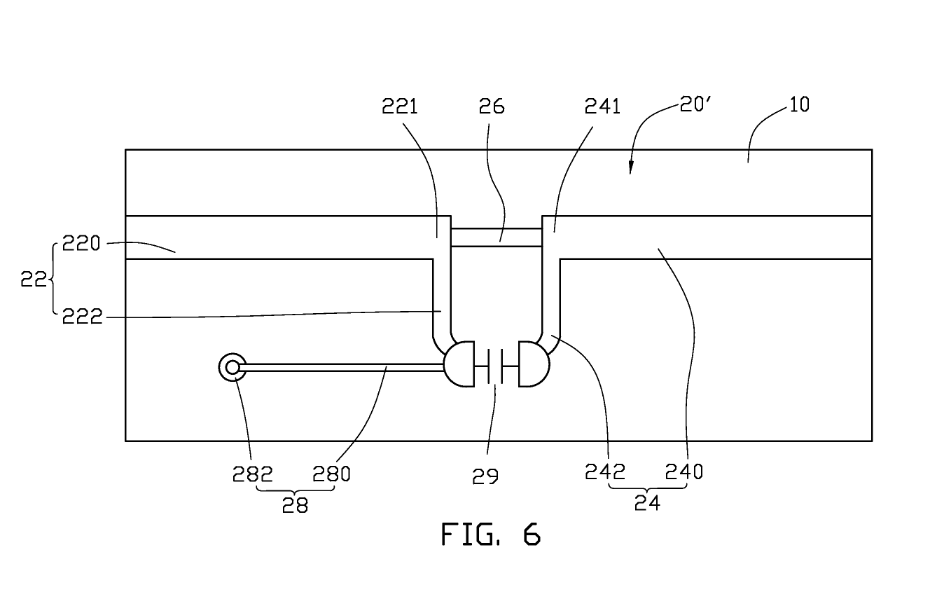

FIG. 6 is a schematic plan view of a UWB filter 20′ of another exemplary embodiment of the present invention. In this embodiment, the UWB filter 20′ is similar to the UWB filter 20 in FIG. 1. The difference therebetween is that the UWB filter 20′ further includes a capacitance component 29 electronically connected to the first transmission portion 22 and the second transmission portion 24.

In this embodiment, the capacitance component 29 electronically connects the connection end 280 to an open end of the second second-conductive section 242. The capacitance component 29 can enhance the coupling effect between the first transmission portion 22 and the second transmission portion 24.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An ultra wideband (UWB) filter disposed on a substrate, the UWB filter comprising:
a first transmission portion for transmitting electromagnetic signals;
a second transmission portion for transmitting the electromagnetic signals;
a connection portion directly and electronically connected to the first transmission portion and the second transmission portion; and
a grounded portion electronically connected to the first transmission portion.

2. The UWB filter as claimed in claim 1, wherein the first transmission portion comprises a first first-conductive section and a first second-conductive section vertically and electronically connected to the first first-conductive section.

3. The UWB filter as claimed in claim 2, wherein the second transmission portion comprises a second first-conductive section and a second second-conductive section vertically and electronically connected to the second first-conductive section.

4. The UWB filter as claimed in claim 3, wherein the length of the first first-conductive section is greater than that of the first second-conductive section and the length of the second first-conductive section is greater than that of the second second-conductive section.

5. The UWB filter as claimed in claim 3, wherein the grounded portion is electronically connected to the first second-conductive section and parallel to the first first-conductive section.

6. The UWB filter as claimed in claim 3, wherein the first first-conductive section is aligned with the second first-conductive section.

7. The UWB filter as claimed in claim 3, wherein the first second-conductive section is parallel to the second second-conductive section.

8. The UWB filter as claimed in claim 3, wherein the first first-conductive section is electronically connected to the first second-conductive section at a first joint, and the second first-conductive section is electronically connected to the second second-conductive section at a second joint.

9. The UWB filter as claimed in claim 8, wherein the connection portion electronically connects the first joint to the second joint.

10. The UWB filter as claimed in claim 3, further comprising a capacitance component electronically connecting the first second-conductive section to the second second-conductive section.

11. The UWB filter as claimed in claim 1, wherein the length of the grounded portion is equal to a quarter wavelength of the working frequency of the UWB filter.

12. A filter assembly comprising:
a substrate; and
a filter disposed on said substrate, said filter comprising a first transmission portion for transmitting electromagnetic signals, and a second transmission portion for transmitting said electromagnetic signals and physically separate from said first transmission portion, said first transmission portion comprising a first conductive section and a second conductive section extending perpendicular away from said first conductive section, said second transmission portion comprising a third conductive section and a fourth conductive section extending perpendicular away from said third conductive section, a connection portion electrically connectable with said first transmission portion at a joint of said first and second conductive sections, and with said second transmission portion at a joint of said third and fourth conductive sections, respectively.

13. The filter assembly as claimed in claim 12, wherein a grounded portion is electrically connectable with said first transmission portion at a distal end of said second conductive section.

14. A filter assembly comprising:
a substrate; and
a filter disposed on said substrate, said filter comprising a first transmission portion for transmitting electromagnetic signals, and a second transmission portion for transmitting said electromagnetic signals and physically separate from said first transmission portion, said first transmission portion comprising a first conductive section and a second conductive section extending perpendicular away from said first conductive section, said second transmission portion comprising a third conductive section and a fourth conductive section extending perpendicular away from said third conductive section, said second and fourth conductive sections spatially neighboring each other and extending parallel to each other.

15. The filter assembly as claimed in claim 14, wherein said first conductive section of said first transmission portion extends along a straight line same as said third conductive section of said second transmission portion.

16. The filter assembly as claimed in claim 14, further comprising a connection portion electrically connectable with said first transmission portion at a joint of said first and second conductive sections, and with said second transmission portion at a joint of said third and fourth conductive sections.
